(19) United States
(12) Patent Application Publication
(10) Pub. No.: US 2022/0154920 A1
(43) Pub. Date: May 19, 2022

(54) Scupper Light

(71) Applicant: Peter Andrew Tripp, Virginia Beach, VA (US)

(72) Inventor: Peter Andrew Tripp, Virginia Beach, VA (US)

(21) Appl. No.: 17/338,915

(22) Filed: Jun. 4, 2021

Related U.S. Application Data
(60) Provisional application No. 63/115,919, filed on Nov. 19, 2020.

(51) Int. Cl. F21V 27/02; B63B 45/02; F16B 35/00

(52) U.S. Cl. CPC F21V 27/02; F16B 35/00; B63B 45/02

(57) ABSTRACT

The present application is directed to an apparatus that includes a hollow cylindrical threaded channel providing a circular light housing on one end and a pair of conduits passing through the other end, and a threaded nut disposed on the hollow cylindrical threaded channel with one or more elongated arms extending outward and upward from a base of the threaded nut.

### CROSS-REFERENCE TO RELATED APPLICATION

The present application claims priority to earlier filed U.S. provisional patent application No. 63/115,919 entitled, “SCUPGLOW”, file on Nov. 19, 2020, the entire contents of which is hereby incorporated by reference in its entirety.

### BACKGROUND

Conventionally, accessories and ‘add-ons’ for boats, kayaks, canoes, etc., are expensive and not always tailored for optimum usage. On a kayak, there is very little space and area for storing additional products, such as radios, radar, lights, etc. Also, the electrical components are even more complicated to setup as the electrical wiring and related components can easily come into contact with the water around the kayak.

### SUMMARY

Example embodiments of the present application include an apparatus that includes a hollow cylindrical threaded channel providing a circular light housing on one end and a pair of conduits passing through the other end, and a threaded nut disposed on the hollow cylindrical threaded channel with one or more elongated arms extending outward and upward from a base of the threaded nut.

### BRIEF DESCRIPTION OF THE DRAWING(S)

FIG. 1 illustrates a sideways view of a scupper light configuration with a corresponding housing and V-shaped nut according to an example embodiment of the present application.

FIG. 2 illustrates a bottom view of a scupper light configuration with a corresponding housing and V-shaped nut according to an example embodiment of the present application.

FIG. 3 illustrates an angled sideways view of a scupper light configuration with a corresponding housing and V-shaped nut according to an example embodiment of the present application.

### DETAILED DESCRIPTION

It will be readily understood that the components of the present application, as generally described and illustrated in the figures herein, may be arranged and designed in a wide variety of different configurations. Thus, the following detailed description of the embodiments of an apparatus, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

According to example embodiments, a boat or kayak (hereinafter ‘kayak’) scupper compatible light configuration may include an elongated light housing that can pass through a scupper hole on the bottom of the kayak and provide light under the kayak into the water below.

FIG. 1 illustrates a sideways view of a scupper light configuration with a corresponding housing and V-shaped nut according to an example embodiment of the present application. Referring to FIG. 1, the threaded column 40 is a hollow elongated column made from plastic, metal or a composite of rigid materials that may be formed to make a threaded column 40 where a nut 54 having a main portion which rotates around the threaded column 40 to move the nut up and down the threaded column 40. An upper portion 52 of the nut 54 may be generally circular and affixed to a pair of elongated arms 50 which are generally flexible so they can be tucked into the scupper hole channel of the kayak when tightening the nut down the column 40. The end of the column 40 may have a widened light housing 42 which is also substantially circular and which is made of a shatter resistant material to protect the light 30 extending from the end of the housing.

The elongated nut arms may be generally 45 degrees plus or minus 20 degrees depending on how the nut is designed and the type of material(s) used. The same material may be used for the entire nut housing including the arms 50, the lower and upper portions 52/54 and the angled wing tips 58. The nut may have a metal or other material used where the nut makes contact with the threaded column 40. Or, all the material may be the same, the inside of the nut (not shown) is also a threaded material to match the threaded column 40 for manipulation and positioning. As may be observed, the column 40 has one or more conduits 62/64 providing an electrical current to the light 30 through an empty channel of the housing 42 and the channel of the column 40. The conduits 62/64 may connect to a control station used to control various switches on the boat/kayak or directly to an energy source (i.e., battery source). The angle between the angled wing tips 58 and the elongated arms may be generally greater than 90 degrees but less than 180 degrees. A user may pinch the wings 50 together and turn the nut to secure the light 30 into the scupper so the light 30 peers into the water below the kayak via the passage of the scupper.

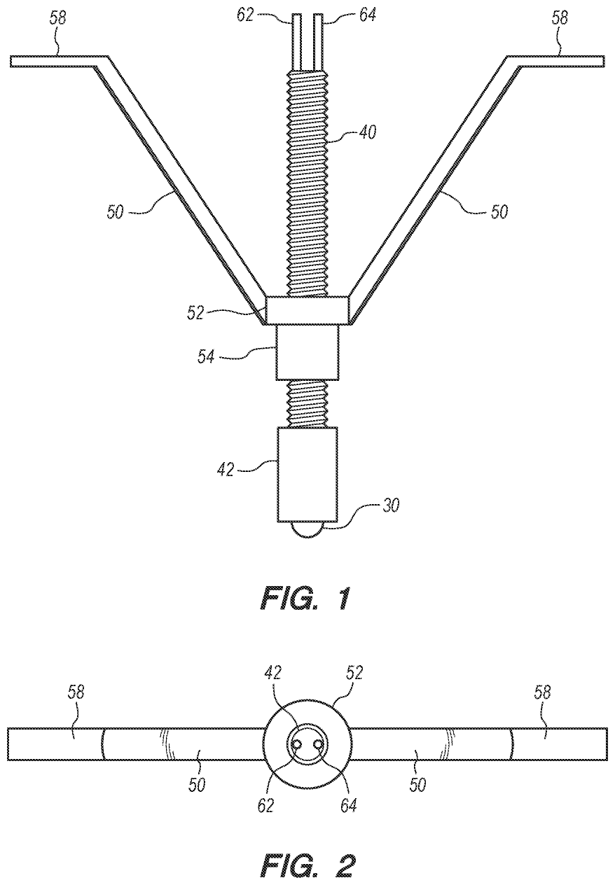

FIG. 2 illustrates a bottom view of a scupper light configuration with a corresponding housing and V-shaped nut according to an example embodiment of the present application. In this view, the rim of the light housing 42 is adjacent to the inside of the column 40. The conduits 60/62 are shown floating around the inside of the column, and the top of the nut is also visible. The wing arms 50 and the tips 58 are also shown extending from the nut center body.

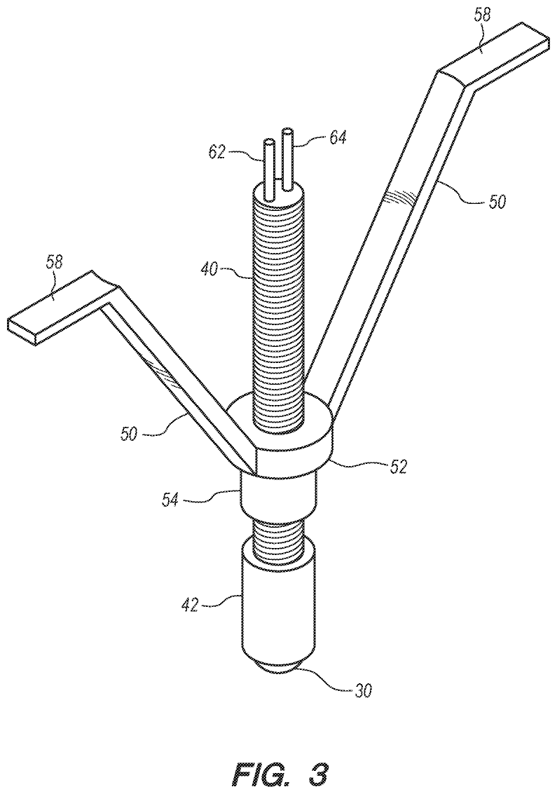

FIG. 3 illustrates an angled sideways view of a scupper light configuration with a corresponding housing and V-shaped nut according to an example embodiment of the present application. In this view, the arms 50 are shown as integrated into the nut body 52. The arms 50 may have a curved lip where the arms 50 are affixed to the nut top portion 52 to embrace the generally circular nut body. In general, the integrated portions of the nut are the same material and are molded to provide a seamless and strong configuration for handling by a user attempting to drive the nut into an optimal position so the light can be securely fitted into the scupper of the bottom of the kayak.

The threaded column may be generally four inches long. The light may be a light emitting diode (LED) with a 9-12 watt capacity. Colors may include green, red and white as some examples. The nut and the various components of the nut may be a rubbery plastic or other friction inducing material to avoid slipping while in the scupper space. The light can be adjusted to move up and down the scupper depending on the position of the nut. The nut size may be ¼ inch or a similar size. The length of the nut arms 50 may be about four inches in length. In one example, the light and the channel may be disposed in the scupper, however, the water can still pass through the scupper to drain back into the water source where the kayak is floating.

One example embodiment may include an apparatus that includes a hollow cylindrical threaded channel providing a circular light housing on one end and a pair of conduits passing through the other end, this allows the light to pass through one end and the wires to extend out the other end of the channel. The apparatus may also include a threaded nut disposed on the hollow cylindrical threaded channel with one or more elongated arms extending outward and upward from a base of the threaded nut.

The elongated arms are angled approximately 45 degrees from an area of the threaded nut contiguous with the hollow cylindrical threaded channel. There are two elongated arms extending from opposite sides of the nut, and the base of the two elongated arms includes curved lips to match a portion of the cylindrical edge of the nut. Top portions of the two elongated arms include flat surfaces, and wherein the angle between the flat surfaces and an angled portion of the elongated arms is approximately 45 degrees. A length of the elongated arms prior to the top flat portions is at least twice as long as a length of the top flat portions of the elongated arms. The elongated arms form wings with a longer sloped portion and shorter flat surface, the longer sloped portion is estimated to be at least twice as long as the flat top surface of the winged shape elongated arms.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

While preferred embodiments of the present application have been described, it is to be understood that the embodiments described are illustrative only and the scope of the application is to be defined solely by the appended claims when considered with a full range of equivalents and modifications thereto.

What is claimed is:

1. An apparatus comprising:
a hollow cylindrical threaded channel providing a circular light housing on one end and a pair of conduits passing through the other end; and
a threaded nut disposed on the hollow cylindrical threaded channel with one or more elongated arms extending outward and upward from a base of the threaded nut.

2. The apparatus of claim 1, wherein the elongated arms are angled approximately 45 degrees from an area of the threaded nut contiguous with the hollow cylindrical threaded channel.

3. The apparatus of claim 1, wherein there are two elongated arms extending from opposite sides of the nut.

4. The apparatus of claim 3, wherein the base of the two elongated arms comprises curved lips to match a portion of the cylindrical edge of the nut.

5. The apparatus of claim 3, wherein top portions of the two elongated arms include flat surfaces, and wherein the angle between the flat surfaces and an angled portion of the elongated arms is approximately 45 degrees.

6. The apparatus of claim 5, wherein a length of the elongated arms prior to the top flat portions is at least twice as long as a length of the top flat portions of the elongated arms.
